(19) United States
(12) Patent Application Publication
(10) Pub. No.: US 2008/0055242 A1
(43) Pub. Date: Mar. 6, 2008

(54) APPARATUS AND METHOD FOR PERFORMING ANALOG INPUT OPERATION IN PORTABLE TERMINAL

(75) Inventor: Min-Woong HWANG, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/850,552

(22) Filed: Sep. 5, 2007

(30) Foreign Application Priority Data
Sep. 5, 2006 (KR) 2006-0085078

(51) Int. Cl. G06F 3/02

(52) U.S. Cl. 345/157

(57) ABSTRACT

An apparatus and method for performing an analog input operation in a portable terminal are provided. The method includes checking first and second coordinates respectively mapped to first and second keys consecutively input; checking an input time difference between the first and second keys; computing a movement direction and a variation of a cursor by referencing to information regarding the first and second coordinates and the input time difference between the first and second keys; and moving the cursor according to the computation result.

### PRIORITY

This application claims priority under 35 U.S.C. §119(a) to a Korean Patent Application filed in the Korean Intellectual Property Office on Sep. 5, 2006 and assigned Serial No. 2006-85078, the contents of which are incorporated herein by reference.

### BACKGROUND OF THE INVENTION

1. Field of the Invention

The present invention relates to an input method of a portable terminal, and in particular, to an apparatus and method for performing an analog input operation using a keypad in a portable terminal.

2. Description of the Related Art

A portable terminal has a keypad to receive a user input. The keypad is composed of a hard key for performing only predetermined functions and a soft key for adaptively performing functions according to the mode of the keypad. Moreover, the operation of the keypad may include a press operation in which an instant when the user presses a key is recognized, a hold operation in which the key remains pressed, and a release operation in which the pressed key is released.

The portable terminal has provided an application program and a user interface in a significantly effective manner in consideration of the aforementioned three-types of operations of the keypad. Recently, however, with the widespread use of portable terminals, user's demands are becoming more and more sophisticated. To satisfy this new demand for a high-end portable terminal, the application program and the user interface are also becoming more and more complex and diverse. Therefore, a conventional keypad input method has its limit in terms of dealing with a variety of application programs and user interfaces.

To solve this problem, the portable terminal may employ an analog input method using a touch screen, a touch pad, and an optical jog. An extra device may be used to provide an analog input interface such as a mouse pointer which is generally used in a Personal Computer (PC), so that a user can use the portable terminal in varying environments.

As described above, the portable terminal may support the analog input method using the extra device. However, a physical structure of the portable terminal may become further complex when using the extra device, which deteriorates the portability aspect of the portable terminal.

### SUMMARY OF THE INVENTION

An aspect of the present invention is to substantially solve at least the above problems and/or disadvantages and to provide at least the advantages below. Accordingly, one aspect of the present invention is to provide an apparatus and method for performing an analog input operation in a portable terminal.

Another aspect of the present invention is to provide an apparatus and method for performing an analog input operation using a keypad included in a portable terminal.

According to one aspect of the present invention, there is provided a method of performing an analog input operation in a portable terminal. The method includes checking first and second coordinates respectively mapped to first and second keys consecutively input; checking an input time difference between the first and second keys; computing a movement direction and a variation of a cursor by referencing to information regarding the first and second coordinates and the input time difference between the first and second keys; and moving the cursor according to the computation result.

According to yet another aspect of the present invention, there is provided an apparatus for a portable terminal. The apparatus includes a keypad for checking two consecutive key inputs generated by a user; a coordinate-information checking unit for checking coordinates corresponding to the two key inputs; a cursor movement operator for computing a movement direction and a variation of a cursor by referring to information regarding the coordinates and an input time difference between the two key inputs; and a controller for controlling the cursor so that the cursor moves according to the computed movement direction and the variation.

According to still another aspect of the present invention, there is provided an apparatus for a portable terminal. The apparatus includes a keypad for checking two consecutive key inputs generated by a user; and a controller for checking coordinates corresponding to the two key inputs, computing a movement direction and a variation of a cursor by referring to information regarding the coordinates and an input time difference between the two key inputs, and controlling the cursor so that the cursor moves according to the computed movement direction and the variation.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a portable terminal according to the present invention;

FIG. 2 is a flowchart of a process of performing an analog input operation using a keypad in a portable terminal according to the present invention;

FIG. 3 illustrates an example of keypad mapping of a portable terminal according to the present invention;

FIGS. 4A to 4C illustrate screens for an analog input operation using a keypad in a portable terminal according to the present invention; and

FIGS. 5A to 5C illustrate screens for an application program using an analog input operation in a portable terminal according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

A technique for performing an analog input operation using a keypad included in a portable terminal of the present invention will be described below.

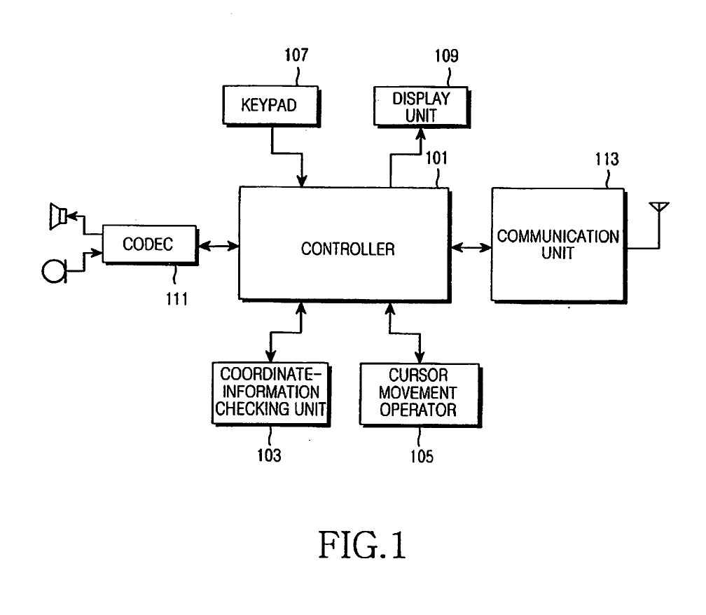

FIG. 1 is a block diagram of a portable terminal according to the present invention. Examples of the portable terminal may include a cellular phone, a Personal Communication System (PCS) phone, a Personal Data Assistant (PDA), and an International Mobile Telecommunication-2000 (IMT2000) terminal. The descriptions below will focus on a general structure of the portable terminal.

In FIG. 1, the portable terminal includes a controller 101, a coordinate-information checking unit 103, a cursor movement operator 105, a keypad 107, a display unit 109, a COder-DECoder (CODEC) 111, and a communication unit 113.

The controller 101 controls overall operations of the portable terminal. For example, the controller 101 may process and control a voice call operation and a data communication operation. In particular, the controller 101 controls a function for performing an analog input operation using the keypad 107.

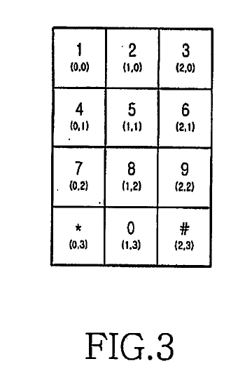

The coordinate-information checking unit 103 checks coordinates mapped to keys input through the keypad 107. For example, when the keypad 107 has a 3×4 size, coordinates may be mapped to respective keys as shown in FIG. 3.

The cursor movement operator 105 computes a movement direction and a variation of a cursor by using coordinate-information and an input time difference between two consecutive key inputs generated within a specific time period. The movement direction is the same as a direction of a vector formed by the coordinates corresponding to the two consecutive key inputs. The variation is computed using Equation (1).

$$Δ L = \frac{s \cdot Δ K}{Δ t} \qquad ( 1 )$$

Here, ΔL denotes the number of pixels to be moved, s denotes a sensitivity constant, ΔK denotes a positional variation between the coordinates corresponding to the two consecutive key inputs, and Δt denotes an input time difference between the two consecutive key inputs.

The controller 101 controls the cursor to move according to the movement direction and the variation computed by the cursor movement operator 105. The coordinates corresponding to the two consecutive key inputs are checked by the coordinate-information checking unit 103, and if the coordinates are identical, the controller 101 allows a double-click operation of the cursor to be performed.

The keypad 107 provides the controller 101 with key input data corresponding to a key pressed by the user. The display unit 109 displays state information, numerals, characters, and images which are produced while the portable terminal operates.

The CODEC 111 converts Pulse Code Modulation (PCM) data provided from the controller 101 into an analog audio signal, and outputs the analog audio signal through a speaker. Further, the CODEC 111 converts the analog audio signal received through a microphone into PCM data and outputs the PCM data to the controller 101. The communication unit 113 processes a Radio Frequency (RF) signal transmitted/received through the antenna.

According to the structure of the portable terminal, the controller 101 may perform functions of the coordinate-information checking unit 103 and the cursor movement operator 105. Although these two functions are separately constructed in the present invention, this is only for description purpose. Therefore, in practice, both or either of the two functions may be processed by the controller 101.

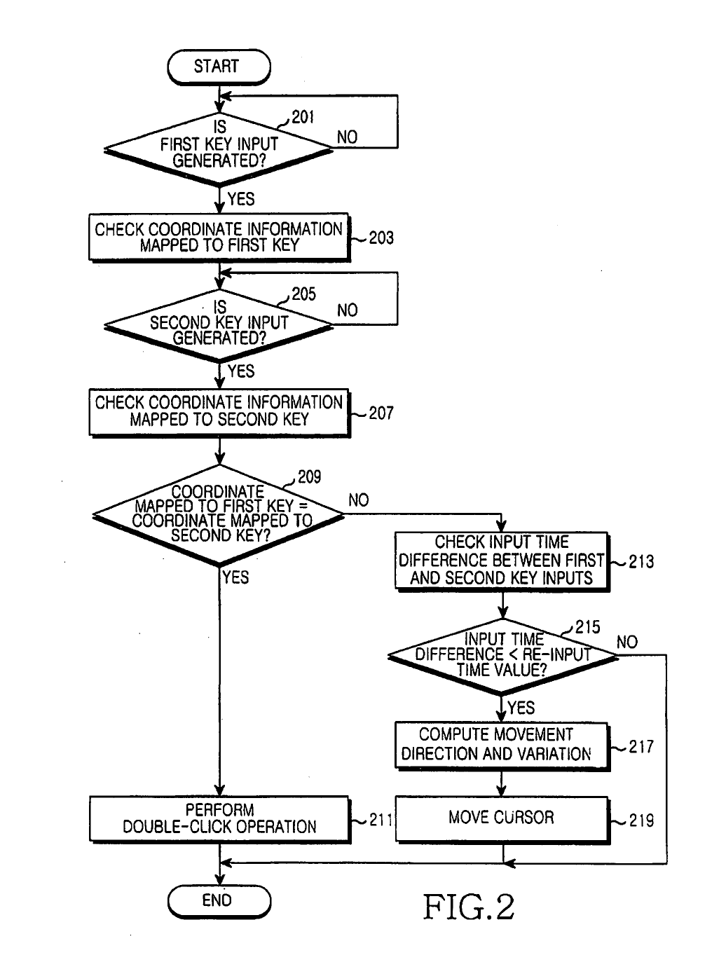

FIG. 2 is a flowchart of a process for performing an analog input operation using a keypad in a portable terminal according to the present invention.

In FIG. 2, the controller 101 detects the generation of a first key input for moving a cursor in step 201.

If the first key input is generated, the controller 101 checks coordinate information mapped to the first key in step 203.

The controller 101 then detects the generation of a second key input for moving the cursor in step 205.

If the second key input is generated, the controller 101 checks coordinate information mapped to the second key in step 207.

The controller 101 then compares the coordinate information mapped to the first key with the coordinate information mapped to the second key in step 209.

If the same coordinate information is mapped to the first and second keys, the controller 101 allows a double-click operation of the cursor to be performed in step 211.

Otherwise, the controller 101 checks an input time difference between the first and second key inputs in step 213.

After checking the input time difference, the controller 101 compares the input time difference with a predetermined re-input time value in step 215.

If the input time difference is greater than or equal to the predetermined re-input time value, the procedure is ended. That is, when an input time difference between two consecutive key inputs is equal to or greater than a predetermined time value, it is determined that the two key inputs are not generated on the purpose of moving the cursor. Thus, to avoid erroneous operations, the re-input time is set to check whether the input time difference exceeds the predetermined re-input time value.

Otherwise, the controller 101 computes a movement direction and a variation of the cursor in step 217.

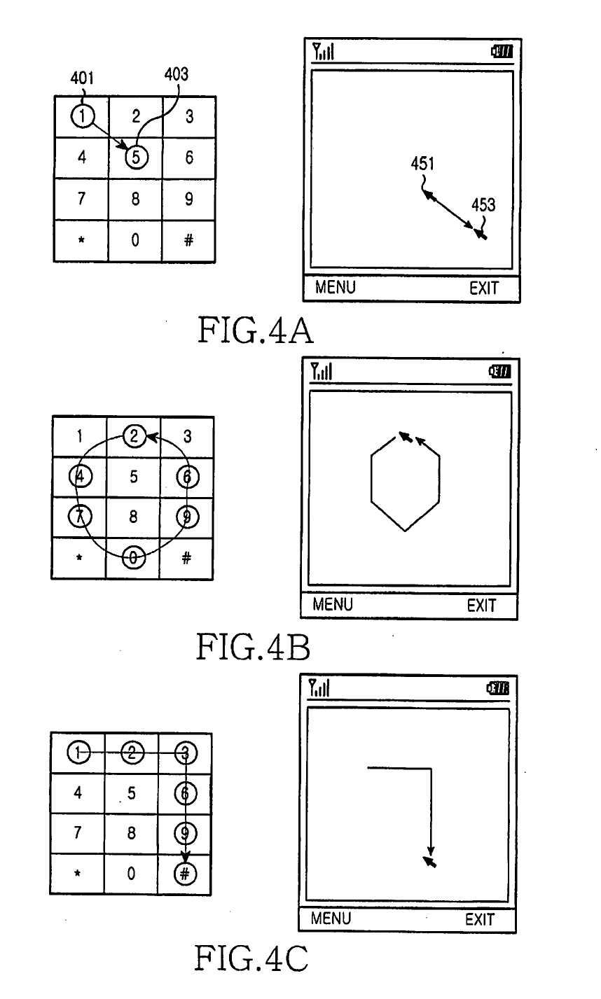

The controller 101 then moves the cursor displayed on the display unit 109 according to the computed movement direction and variation in step 219. For example, by utilizing a keypad mapped as shown in FIG. 3, when a key 401 mapped to ‘1’ and a key 403 mapped to ‘5’ are consecutively input as shown in FIG. 4A, the cursor displayed on the display unit 109 is moved from a first position 451 to a second position 453.

The process is then ended.

In the aforementioned embodiment, the process has been described in which cursor movement is achieved by checking the two consecutive key inputs in the portable terminal. In the case where three consecutive key inputs are generated, the cursor is first moved in response to first and second key inputs, and is then moved in response to second and third key inputs. That is, when N consecutive key inputs are generated, cursor movements are made by N−1 times. Here, for each of the N consecutive key inputs, an input time difference between two consecutive key inputs assumes to be less than the aforementioned re-input time.

Once the present invention is implemented, the user may generate a series of key inputs by touching the keypad to move the cursor as shown in FIGS. 4B and C. When the aforementioned procedure is repeated according to the series of key inputs, the cursor may be moved in the same pattern as the key inputs.

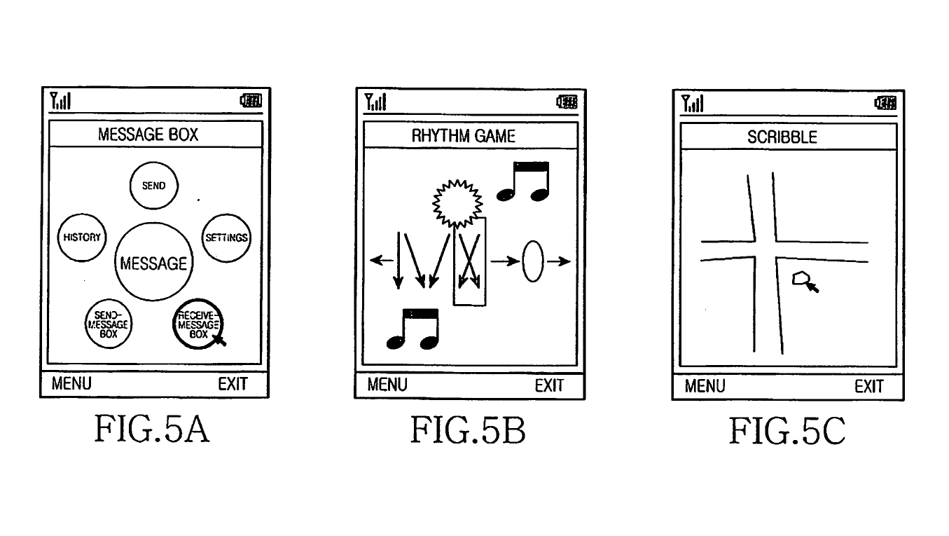

The present invention may apply to the configuration of an interface using an analog cursor as shown in FIG. 5A. In addition, the present invention may also apply to a game using an analog input as shown in FIG. 5B and a notepad using an analog input as shown in FIG. 5C.

According to the present invention, an analog input operation is performed using a keypad included in a portable terminal. Therefore, an interface employing the analog input operation as well as a value-added function can be provided without having to use an extra device.

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDs), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

While the invention has been shown and described with reference to certain preferred embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A method of performing an analog input operation in a portable terminal, comprising:
checking first and second coordinates respectively mapped to first and second keys consecutively input;
checking an input time difference between the first and second keys;
computing a movement direction and a variation of a cursor by referencing to information regarding the first and second coordinates and the input time difference between the first and second keys; and
moving the cursor according to the computation result.

2. The method of claim 1, wherein the movement direction is the same as a direction of a vector directed from the first coordinate towards the second coordinate.

3. The method of claim 1, wherein the variation is computed according to
$$Δ L = \frac{s \cdot Δ K}{Δ t} ,$$
where s denotes a sensitivity constant, ΔK denotes a positional variation between the first and second coordinates, and Δt denotes the input time difference between the first and second keys.

4. The method of claim 1, further comprising:
checking the first and second coordinates to determine whether the two coordinates are identical; and
performing a double-click operation of the cursor.

5. The method of claim 1, further comprising checking the input time difference between the first and second keys to determine whether the input time difference is less than a predetermined time value.

6. An apparatus for a portable terminal, comprising:
a keypad for checking two consecutive key inputs generated by a user;
a coordinate-information checking unit for checking coordinates corresponding to the two key inputs;
a cursor movement operator for computing a movement direction and a variation of a cursor by referring to information regarding the coordinates and an input time difference between the two key inputs; and
a controller for controlling the cursor so that the cursor moves according to the computed movement direction and the variation.

7. The apparatus of claim 6, wherein the movement direction is the same as a direction of a vector formed by the coordinates.

8. The apparatus of claim 6, wherein the variation is computed according to
$$Δ L = \frac{s \cdot Δ K}{Δ t} ,$$
where s denotes a sensitivity constant, ΔK denotes a positional variation between coordinates corresponding to the two key inputs, and Δt denotes the input time difference between the two key inputs.

9. The apparatus of claim 6, wherein the controller allows a double-clink operation of the cursor when the coordinates corresponding to the two key inputs are identical.

10. The apparatus of claim 6, wherein the controller checks the input time difference between the two key inputs, and, if the input time difference is less than a predetermined time value, allows the cursor to be moved.

11. A portable terminal for performing an analog input operation comprising:
means for checking first and second coordinates respectively mapped to first and second keys consecutively input;
means for checking an input time difference between the first and second keys;
means for computing a movement direction and a variation of a cursor by referencing to information regarding the first and second coordinates and the input time difference between the first and second keys; and
means for moving the cursor according to the computation result.

12. A portable terminal of claim 11, wherein the variation is computed according to
$$Δ L = \frac{s \cdot Δ K}{Δ t} ,$$
where s denotes a sensitivity constant, ΔK denotes a positional variation between the first and second coordinates, and Δt denotes the input time difference between the first and second keys.

13. A method of performing an analog input operation in a portable terminal, comprising:
computing a movement, direction and a variation of a cursor by referencing to information regarding a first coordinate and a second coordinate and an input time difference between a first key and a second key; and
moving the cursor according to the computation result.

14. The method of claim 13, wherein the variation is computed according to
$$Δ L = \frac{s \cdot Δ K}{Δ t} ,$$
where s denotes a sensitivity constant, ΔK denotes a positional variation between the first and second coordinates, and Δt denotes the input time difference between the first and second keys.

15. A computer-readable recording medium having recorded thereon a program for performing an analog input operation, comprising:
a first code segment, checking first and second coordinates respectively mapped to first and second keys consecutively input;
a second code segment, checking an input time difference between the first and second keys;
a third code segment, computing a movement direction and a variation of a cursor by referencing to information regarding the first and second coordinates and the input time difference between the first and second keys; and
a fourth code segment, moving the cursor according to the computation result.

16. The computer-readable recording medium having recorded thereon a program of claim 15, wherein the movement direction is the same as a direction of a vector directed from the first coordinate towards the second coordinate.

17. The computer-readable recording medium having recorded thereon a program of claim 15, wherein the variation is computed according to
$$Δ L = \frac{s \cdot Δ K}{Δ t} ,$$
where s denotes a sensitivity constant, ΔK denotes a positional variation between the first and second coordinates, and Δt denotes the input time difference between the first and second keys.

18. The computer-readable recording medium having recorded thereon a program of claim 15, further comprising:
a fifth code segment, checking the first and second coordinates to determine whether the two coordinates are identical; and
a sixth code segment, performing a double-click operation of the cursor.

19. The computer-readable recording medium having recorded thereon a program of claim 15, further comprising:
a seventh code segment, checking the input time difference between the first and second keys to determine whether the input time difference is less than a predetermined time value.
